(19) United States
(12) Patent Application Publication
(10) Pub. No.: US 2026/0051046 A1
(43) Pub. Date: Feb. 19, 2026

(54) Method and Apparatus for the Spatially Resolved Localization of a Defect in a Component

(71) Applicant: Robert Bosch GmbH, Stuttgart (DE)

(72) Inventor: David Walther Schoenleber, Karlsruhe (DE)

(21) Appl. No.: 19/295,567

(22) Filed: Aug. 9, 2025

(30) Foreign Application Priority Data
Aug. 14, 2024 (DE) 10 2024 207 745.3

(51) Int. Cl. G06T 7/00; G06T 7/73; G06V 10/762; G06V 10/764; G06V 10/776

(52) U.S. Cl. CPC G06T 7/001; G06T 7/74; G06V 10/763; G06V 10/764; G06V 10/776; G06T 2207/30108; G06V 2201/06

(57) ABSTRACT

A method for the spatially resolved localization of a defect in a component includes (i) providing a saliency map of a NOK image or a NOK defect class image of a component exhibiting a defect, (ii) applying at least one dimension reduction method to the provided saliency map to generate a dimension-reduced saliency map, and (iii) spatially resolved localization of the defect of the component on the basis of the dimension-reduced saliency map.

This application claims priority under 35 U.S. C. § 119 to application no. DE 10 2024 207 745.3, filed on Aug. 14, 2024 in Germany, the disclosure of which is incorporated herein by reference in its entirety.

The disclosure relates to a method for the spatially resolved localization of a defect in a component. The disclosure also relates to an apparatus for the spatially resolved localization of a defect in a component. The disclosure also relates to an automatic optical inspection (AOI) system, a computer program with program code, and a computer-readable data carrier with program code for a computer program.

### BACKGROUND

In the field of machine learning, the effective examination and labeling of data plays a crucial role, especially in applications such as image classification. A common method for simplifying and improving this process is to visualize the data in a low-dimensional space, a process known as dimensionality reduction. This approach greatly facilitates the interpretation of complex data sets and allows patterns and structures within the data to be better recognized.

In manufacturing, automated optical inspection (AOI) systems play a role in detecting defects at various stages of production. These AOI systems rely on deep learning-based image classification models that are trained to distinguish between acceptable (OK) and defective (NOK) components represented in the captured images and/or to detect certain types of defects (e.g., cracks, indentations, bulges, etc.). To train these machine learning models, experts review the images captured by the production line and often manually label them as OK, NOK, and/or assign them to specific defect categories. This labeling process traditionally focuses on the presence of defects rather than their specific location on the component.

However, understanding where defects occur on a component can provide valuable insights for experts. The position of a defect can reveal, for example, which stages in the manufacturing process are particularly prone to errors or could be optimized for better performance.

The output data can be in its raw form or as feature vectors derived from various machine learning models, such as autoencoders or pre-trained image classification models (see Jia, W., Sun, M., Lian, J. et al. Feature dimensionality reduction: a review. Complex Intell. Syst. 8, 2663-2693 (2022)). Applying dimensionality reduction to such feature vectors has the advantage of not only simplifying the visualization of the data, but also facilitating the identification of mislabeled images.

However, there are significant limitations. While feature vectors can capture semantic differences between different image categories, they are generally unable to determine the exact position or type of defects in the images. This limitation highlights the need to develop and deploy complementary techniques to accurately detect and categorize the location and type of defects within images. This challenge is of great importance for further improving the quality and reliability of image classification models.

It is an object of the disclosure to provide an improved method and/or apparatus in this respect.

The problem is solved by a method according to the features of the disclosure set forth below. The problem is solved by an apparatus according to the features of the disclosure set forth below.

### SUMMARY

According to a first aspect, a method for the spatially resolved localization of a defect in a component is proposed. The method comprises the following steps:
providing a saliency map of a NOK image or a NOK defect class image of a component exhibiting a defect;
applying at least one dimension reduction method to the provided saliency map to generate a dimension-reduced saliency map; and
spatially resolved localization of the defect of the component on the basis of the dimension-reduced saliency map.

It is understood that the steps according to the disclosure and further optional steps do not necessarily have to be carried out in the order shown, but may also be carried out in a different order. Furthermore, intermediate steps may also be provided. The individual steps may also comprise one or more sub-steps without going beyond the scope of the method according to the disclosure.

According to a second aspect, an apparatus for the spatially resolved localization of a defect in a component is proposed. The apparatus comprises an evaluation and calculation unit that is configured to perform the following steps:
providing a saliency map of a NOK image or a NOK defect class image of a component exhibiting a defect;
applying at least one dimension reduction method to the provided saliency map to generate a dimension-reduced saliency map; and
spatially resolved localization of the defect of the component on the basis of the dimension-reduced saliency map.

The explanations given for the method apply to the apparatus accordingly. In this regard, any linguistic modifications of features formulated in terms of the method can be reformulated for the apparatus in accordance with standard linguistic practice, without such formulations having to be explicitly listed here.

Class contrastive image mapping techniques, including Grad-CAM and its variants, as well as disturbance-based methods preferably generate saliency maps. These saliency maps visually highlight regions within an image that significantly influence the classification decision of the machine learning model. Essentially, each pixel in a saliency map is assigned a scalar value that represents its importance and/or contribution to the classification result. If an optimized classification model is used to create the saliency map and the defects can be localized in the image in this way, a position of the defect(s) can be highlighted in the saliency map of an image classified as non-OK. A saliency map is therefore a visual tool used in image processing and machine learning to highlight the most prominent or important parts of an image.

These maps show which areas of an image attract the most attention, based on certain features such as brightness, color, contrast, or movement. In computer vision, the saliency maps are used for object detection and tracking by highlighting areas that are important to the task.

Further, they are used to explain model decisions by showing what parts of an image were important for the classification or other decisions. For example, saliency maps are represented as gray-scale images, wherein brighter areas indicate higher saliency (i.e., greater prominence) and darker areas indicate lower saliency. They can also be colored to make the differences even more clear.

The method can be used in conjunction with Automatic Optical Inspection (AOI), where operations engineers want to quickly inspect or monitor location-based defect types in images classified as NOK by a classification model. The proposed method assists the user of such AOI systems in quickly identifying and/or analyzing location-specific defect types in image data that have been classified as out of order (NOK) by an automated optical inspection (AOI) system. In the context of manufacturing, the position of a defect on or at a product or component can be associated with certain root causes, such as certain tool positions and/or manufacturing parameters. By using this technology, experts can efficiently examine and categorize defects based on their position. By monitoring the occurrence of different site-specific defect types over time, this approach can also serve as a tool for assessing the stability of the production process. Tracking defects can reveal trends and/or shifts in production quality, enabling timely intervention to rectify potential problems.

The method is applied to image data or video data that is preferably captured or recorded by an optical sensor, such as a camera, during a manufacturing process of a product or component in order to determine whether a product or component is acceptable (OK component) or unacceptable (NOK component).

In a further aspect, it is proposed that the dimension reduction method comprises a PCA method or a UMAP method or a t-SNE method or a PacMAP method, and wherein the dimension reduction method reduces a multi-dimensionality of the saliency map to a two-dimensionality of the saliency map. If the dimensionality of the saliency map is very large (e.g. >1000), it can first be reduced using a dimensionality reduction method such as principal component analysis (PCA) before the remaining dimensions are further reduced using the UMAP, t-SNE or PacMAP method.

By reducing the dimension of the saliency map using dimensionality reduction techniques such as PCA, t-SNE, UMAP or PaCMAP, a spatial structure included in the saliency map can be distilled into a low-dimensional visualization space. This makes it easier for a user to identify and/or categorize location-specific defects. The saliency map was preferably created for images that an image classification model, such as a machine learning model, has identified as NOK. When dealing with multiple defect classes, the present approach preferably comprises performing a dimensionality reduction for each class of defects separately.

Principal component analysis (PCA) is a linear dimension reduction method used to visualize and analyze high-dimensional data. It transforms the data into a new coordinate system, wherein the principal components represent the directions of maximum variance in the data. PCA emphasizes the global structure of the data by reducing the dimensions while retaining the most important patterns of variation.

The UMAP method (Uniform Manifold Approximation and Projection) is a non-linear dimension reduction method used for the visualization and clustering of high-dimensional data. It emphasizes the local structure in the data and at the same time preserves the global structures.

The t-SNE method (t-distributed Stochastic Neighbor Embedding) is a non-linear dimension reduction method used for the visualization of high-dimensional data. It reduces the dimensions of the data by placing similar objects close together in the lower dimension. t-SNE is particularly useful for small to medium-sized data sets.

The PacMAP method (Pairwise Controlled Manifold Approximation Projection) focuses on the pairwise approximation and projection of data. This method retains both local and global structures in the data and is optimized to preserve the structure and distribution of the data.

In a further aspect, it is proposed that the saliency map can be generated in particular by a Grad-CAM-based or a disturbance-based method based on a classification result of a machine learning model, by way of which the image of the component can be classified as OK or NOK.

In this disclosure, we propose a method for visualizing and potentially clustering the results of dimensionality reduction, which is applied in particular to class-contrastive saliency maps, also known as “explainability heatmaps. ” The application is preferably used for images of components that are classified as not OK (NOK) or that represent certain defect classes. Saliency maps, which are generated by class-contrastive techniques such as Grad-CAM and its variants, preferably emphasize areas within an image that significantly influence its classification.

Some saliency or explanation methods, including layer-based image mapping techniques such as Grad-CAM and its variants or disturbance-based approaches that use large perturbed patch sizes, produce saliency maps with lower resolutions than the images underlying the original classification. In such cases, it is preferable to perform the dimensionality reduction on these lower-resolution saliency maps. However, if the saliency maps retain the original image resolution, the dimensionality reduction should be applied directly to these high-resolution saliency maps.

In a further aspect, it is proposed that the method further comprises clustering the dimension-reduced saliency map, in particular to summarize defect groups and/or defect types.

The dimensional reduction of the saliency map considerably facilitates the spatially resolved localization of the defects of the component or the exploration of the various defect locations in the images of the component. The clustering of the defect locations leads to further refinement of the localization analysis of the defect locations of the component. The feasibility of this clustering preferably depends on a specific manufacturing process of the component and/or a variety of defects of the component that can occur during the manufacture or production of the component.

In a further aspect, it is proposed that a local displacement of clusters over a period of time is detectable, wherein a process action for a manufacturing process of the component can be triggered on the basis of the displacement of at least one of the clusters.

It is therefore possible to track the frequency of NOK components, especially in each spatially resolved defect cluster, over time. In addition to classification predictions for the defect clusters during model provision, saliency and conspicuity maps are preferably also created and an adaptive dimensionality reduction transformation such as UMAP is used. The integration of this saliency map data into a comprehensive monitoring system then enables, for example, warning messages to be activated when certain errors or defects, especially those that depend on specific locations, occur more frequently. This proactive approach improves the ability to address and mitigate quality issues in the manufacturing process.

In a further aspect, it is proposed that the NOK image or the NOK defect class image of the component is superimposed with the dimension-reduced saliency map in order to optimize a spatially resolved identification of the defect.

Furthermore, a system for automatic optical inspection (AOI) with an optical sensor, in particular a camera, is proposed. The optical sensor is designed to capture images of a component. Furthermore, the system has a calculation unit, which is designed to carry out the present method and thus enable a spatially resolved localization of a defect in the component on the basis of the captured image data.

In a further aspect, a computer program comprising program code is claimed for executing at least parts of the present method in one aspect thereof when the computer program is executed on a computer. In other words, the computer program (product) comprises commands that, when the program is executed by a computer, cause the computer to perform the steps of the method in one of its embodiments.

In a further aspect, a computer readable data carrier comprising program code of a computer program is proposed for executing at least parts of the present method in one of its aspects when the computer program is executed on a computer. In other words, the disclosure relates to a computer-readable (storage) medium comprising commands which, when executed by a computer, cause the computer to execute the method/steps of the method in one of its aspects.

The described embodiments and refinements may be combined with one another as desired.

Further possible designs, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

FIG. 1 shows a schematic flowchart of an exemplary embodiment of the present method.

FIG. 2 shows a visual illustration of different defect positions, which can be seen from significance maps projected onto a low-dimensional embedding space.

In the figures of the drawings, identical reference numbers denote identical or functionally identical elements, parts or components, unless stated otherwise.

### DETAILED DESCRIPTION

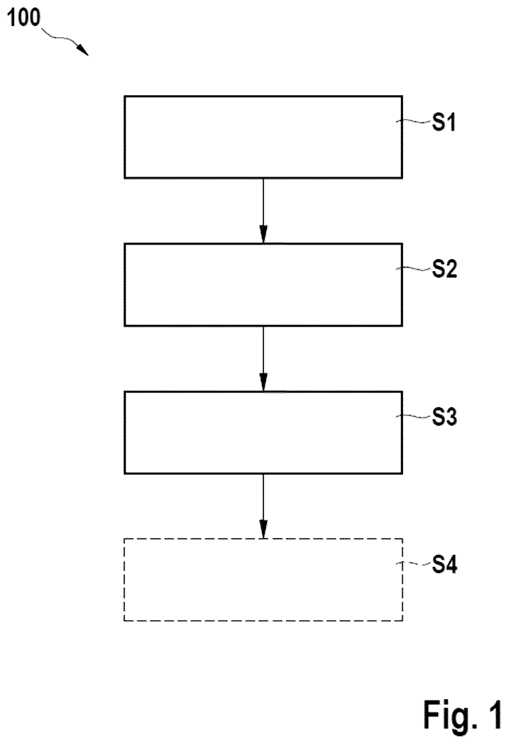

FIG. 1 shows a schematic flowchart of a method for the spatially resolved localization of a defect in a component.

The method can be carried out in any embodiment, at least in part, by an apparatus 100 which may comprise several components not shown in detail, for example one or more provision devices and/or at least one evaluation and calculation unit. It is understood that the provision device may be configured so as together with the evaluation-and-calculation unit or may be different from it. Furthermore, the apparatus 100, which may be part of a system, may comprise a storage device and/or an output device and/or a display device and/or an input device.

The computer-implemented method comprises at least the following steps:

In a step S1, a saliency map of an NOK image or an NOK defect class image of a component exhibiting a defect is provided.

In a step S2, one or more dimension reduction method(s) is/are applied to the provided saliency map to generate a dimension-reduced saliency map.

In step S3, the defect of the component is spatially resolved localization on the basis of the dimension-reduced saliency map.

Optionally, the method may comprise a clustering of the dimension-reduced saliency map in a step S4, in particular to summarize defect groups and/or defect types.

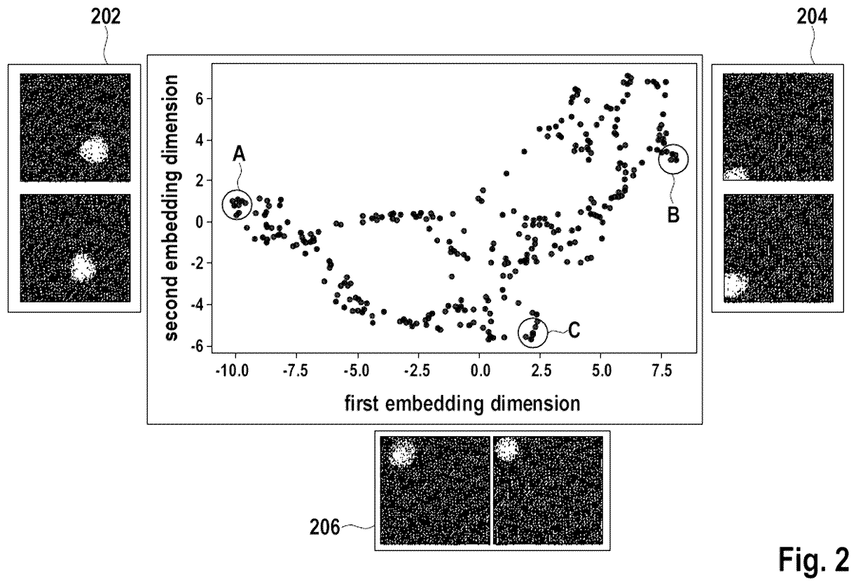

FIG. 2 shows a visual illustration of various defect positions A, B, C of defects of a component that was detected during an automatic optical inspection (AOI) by an optical sensor, for example a camera. The defect positions are shown in a dimension-reduced saliency map 200. The dimension-reduced saliency map 200 has two dimensions. The dimension-reduced saliency map 200 has been reduced by a dimension reduction method starting from a multi-dimensionality, for example 7-dimensionality or 200-dimensionality, wherein the information from a plurality of high-dimensional saliency maps 202, 204, 206 is projected onto a low-dimensional embedding space. For each type or class or type of defect, at least one originally provided saliency map 202, 204, 206 was dimension-reduced. It is also possible to cluster the different defect types or classes, in particular to summarize defect groups and/or defect types.

What is claimed is:

1. A method for the spatially resolved localization of a defect of a component, comprising:
providing a saliency map of a NOK image or a NOK defect class image of a component exhibiting the defect;
applying at least one dimension reduction method to the provided saliency map to generate a dimension-reduced saliency map; and
performing spatially resolved localization of the defect of the component on the basis of the dimension-reduced saliency map.

2. The method according to claim 1, wherein the dimension reduction method comprises a PCA method or a UMAP method or a t-SNE method or a PacMAP method, and wherein the dimension reduction method reduces a multi-dimensionality of the saliency map to a two-dimensionality of the saliency map.

3. The method according to claim 1, wherein the saliency map provided is generated by a Grad-CAM-based or a disturbance-based method based on a classification result of a machine learning model, by way of which the image of the component is classified as OK or NOK.

4. The method according to claim 1, further comprising clustering the dimension-reduced saliency map to combine defect groups and/or defect types.

5. The method according to claim 4, wherein a local displacement of clusters over a period of time is be detected, and wherein a process action for a manufacturing process of the component is triggered on the basis of the displacement of at least one of the clusters.

6. The method according to claim 4, wherein the NOK image or the NOK defect class image of the component is superimposed on the dimension-reduced saliency map in order to optimize the spatially resolved identification of the defect.

7. A system for automatic optical inspection comprising an optical sensor which is designed to capture images of a component, and a calculation unit which is designed to carry out the method according to claim 1 and, on the basis of the captured image data, to enable the spatially resolved localization of a defect of the component.

8. A computer program having program code to execute at least portions of the method according to claim 1 if the computer program is executed on a computer.

9. A computer-readable data carrier having program code of a computer program to execute at least portions of the method according to claim 1 if the computer program is executed on a computer.

10. An apparatus for the spatially resolved localization of a defect in a component, wherein the apparatus has an evaluation and calculation unit, which is designed to carry out the following steps:
providing a saliency map of a NOK image or a NOK defect class image of a component exhibiting a defect;
applying at least one dimension reduction method to the provided saliency map to generate a dimension-reduced saliency map; and
spatially resolved localization of the defect of the component on the basis of the dimension-reduced saliency map.

11. The system of claim 7, wherein the optical sensor is a camera.
